(19) United States
(12) Patent Application Publication
(10) Pub. No.: US 2003/0046843 A1
(43) Pub. Date: Mar. 13, 2003

(54) Device for reflecting patterns into spatial images

(76) Inventor: Fu Wan Chien, Taichung Hsien (TW)

Correspondence Address: CHARLES E. BAXLEY, 5th Floor, 59 John Street, New York, NY, 10038, US

(21) Appl. No.: 10/106,630

(22) Filed: Mar. 27, 2002

(30) Foreign Application Priority Data
Sep. 11, 2001 (CN) 01 2 62758.5

(51) Int. Cl. G09F 13/16

(52) U.S. Cl. 40/582

(57) ABSTRACT

A reflective device includes a cover sheet member having one or more patterns applied on one of its sides. The cover sheet member includes a rugged surface for reflecting the pattern into a spatial image. The patterns may be directly applied onto the cover sheet member, or may be indirectly applied onto a base sheet member before the base sheet member is attached or secured onto the cover sheet member. The reflective device may be manufactured with inexpensive sheet members and by simple and quick manufacturing processes without specialized or skillful persons.

### BACKGROUND OF THE INVENTION

1. Field of the Invention

The present invention relates to a reflective device, and more particularly to a reflective device for reflecting planer figures into spatial images.

2. Description of the Prior Art

Typical reflective devices comprise a transparent or semi-transparent sheet material having drawing figures or characters or words or paintings or pictures or any other patterns applied thereon with such as painting or printing processes. A highly reflective paper or metal sheet or the like is then attached to the sheet material for reflecting the patterns on the sheet material into spatial images. The typical reflective devices may be attached onto the shoes, the purses, the suitcases etc., for decorative purposes. However, the highly reflective paper sheets or metal sheets or the like are expensive and may not be easily manufactured without specialized persons.

The present invention has arisen to mitigate and/or obviate the afore-described disadvantages of the conventional reflective devices.

### SUMMARY OF THE INVENTION

The primary objective of the present invention is to provide a reflective device for reflecting drawing figures or patterns into spatial images.

The other objective of the present invention is to provide a reflective device that may be manufactured with inexpensive materials, and simple and quick manufacturing processes without specialized or skillful persons.

In accordance with one aspect of the invention, there is provided a reflective device comprising a cover sheet member including at least one pattern provided thereon. The cover sheet member includes a rugged surface formed thereon for reflecting the pattern into a spatial image. The reflective device may be manufactured with inexpensive materials, and by simple and quick manufacturing processes without specialized or skillful persons.

The cover sheet member includes a first side and an opposite second side, the pattern is provided on the first side of the cover sheet member, and the rugged surface is formed in the second side of the cover sheet member.

A base sheet member is further provided and attached onto the cover sheet member, the pattern is applied on the base sheet member. The patterns may be directly applied onto the cover sheet member, or may be indirectly applied onto the base sheet member before the base sheet member is attached or secured onto the cover sheet member.

The pattern includes a shape corresponding to that of the base sheet member, and the base sheet member includes an outer peripheral portion and includes a margin formed between the outer peripheral portion of the base sheet member and the pattern.

The base sheet member preferably includes a shape corresponding to that of the cover sheet member.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a reflective device in accordance with the present invention;

FIG. 2 is a cross sectional view taken along lines 2-2 of FIG. 1;

FIG. 3 is a partial exploded view illustrating the format ion or the manufacturing of the reflective device;

FIG. 4 is a front perspective view illustrating the formation or the manufacturing of the reflective device;

FIG. 5 is a rear perspective view illustrating the formation or the manufacturing of the reflective device;

FIG. 6 is a perspective illustrating the mold device for forming or manufacturing the reflective device; and

FIG. 7 is a cross sectional view taken along lines 7-7 of FIG. 6.

### DETAILED DESCRIPTION OF THE PREFERRED EMBODIMENT

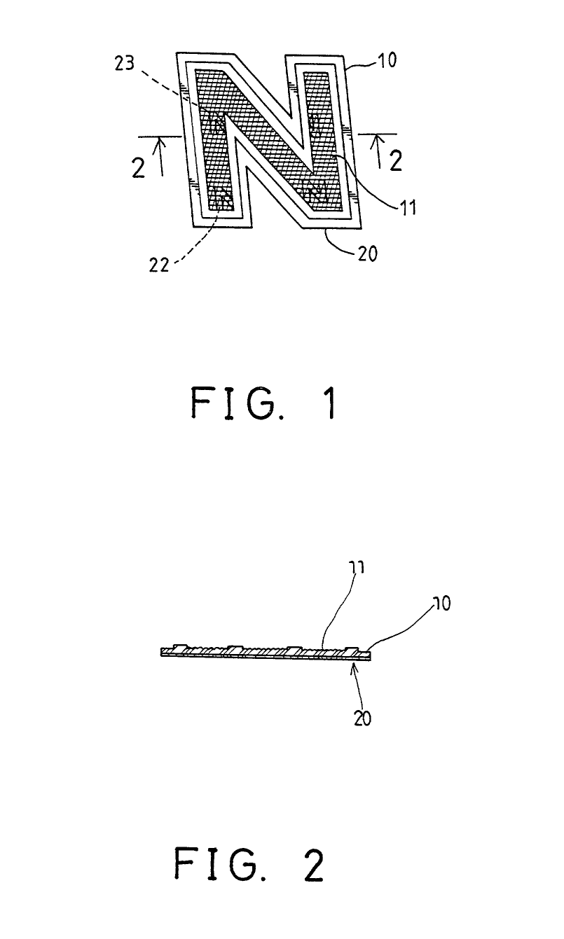

Referring to the drawings, and initially to FIGS. 1 and 2, a reflective device in accordance with the present invention comprises a transparent or semi-transparent cover sheet member 10, and one or more patterns 22, 23 applied or attached onto such as the inner side of the cover sheet member 10. The transparent or semi-transparent cover sheet member 10 includes one of its sides, such as the front or the outer side thereof having a uneven or a rugged or a convex and concave surface 11, such as a serrated or netting surface formed therein for reflecting the patterns 22, 23 or for forming the patterns 22, 23 into a spatial image when seeing through the uneven or rugged or convex and concave surface 11 of the cover sheet member 10.

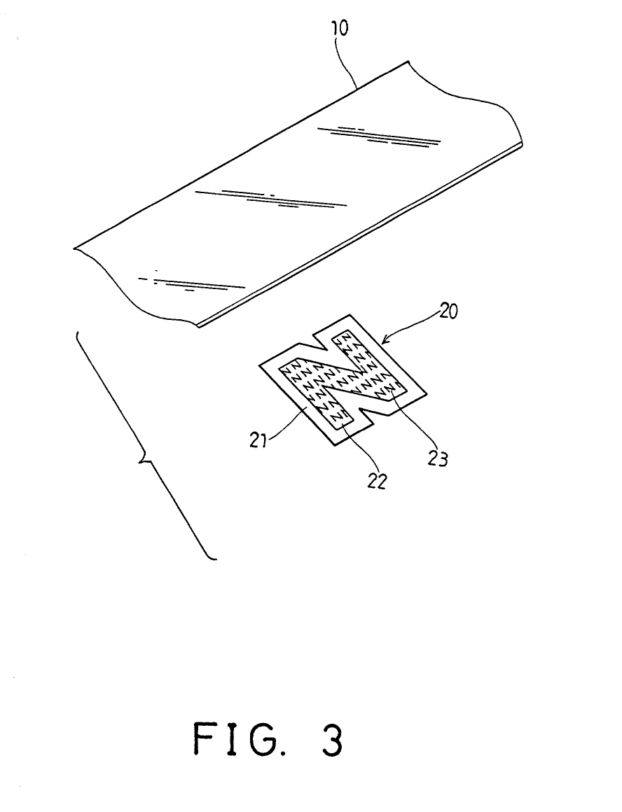

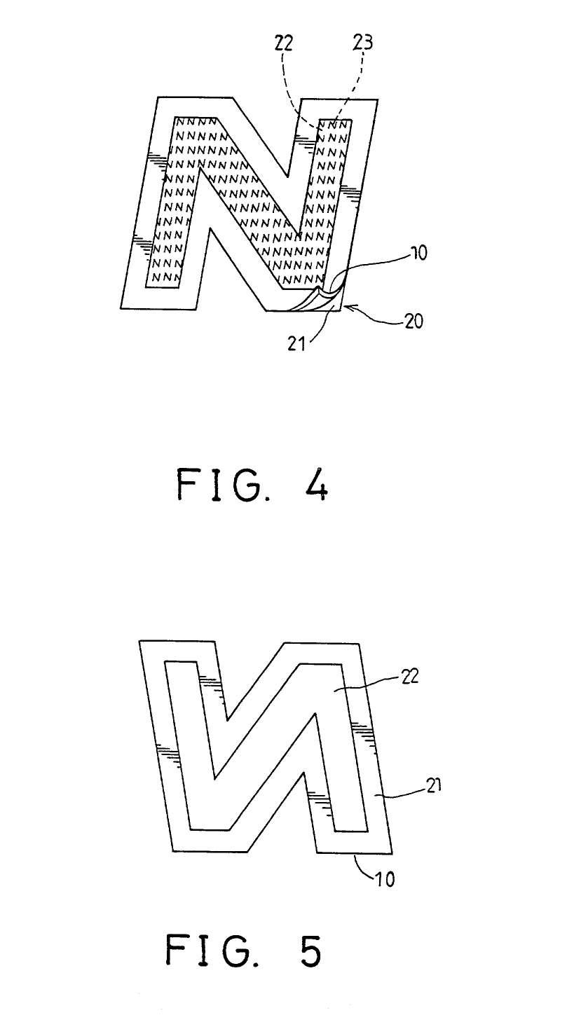

Referring next to FIGS. 3-5, illustrated is the formation or the manufacturing of the reflective device. A base sheet member 20 may be provided and may be shaped into any kind of shapes, and includes one or more patterns 22, 23 applied thereon, with such as the painting or printing processes, and includes a margin 21 formed or provided between the patterns 22, 23 and the outer peripheral portion of the base sheet member 20. The base sheet member 20 may be attached onto the transparent or semi-transparent cover sheet member 10 with adhesive materials, or by welding processes, such as the ultrasonic welding processes.

For example, a N-shaped larger pattern 22 is formed or applied onto the base sheet member 20 which preferably includes one or more colors different from that of the margin 21 of the base sheet member 20, and which preferably includes a shape corresponding to that of the base sheet member 20. A number of smaller patterns 23 may further be formed or applied onto the base sheet member 20, such as formed or applied within the pattern 22 of the base sheet member 20; and preferably include one or more colors different from that of the pattern 22 and/or of the margin 21 of the base sheet member 20; and are preferably arranged into a shape corresponding to that of the base sheet member 20 and/or of the pattern 22.

Alternatively, without the base sheet member 20, the patterns 22, 23 may be directly formed or applied or printed or painted onto the cover sheet member 10 instead of being formed or applied or printed or painted onto the base sheet member 20 and then attached onto the cover sheet member 10. For allowing the patterns 22, 23 to be seen as a spatial pattern or spatial image, the uneven or rugged or convex and concave surface 11 is then required to be formed on the front or outer portion of the transparent or semi-transparent cover sheet member 10.

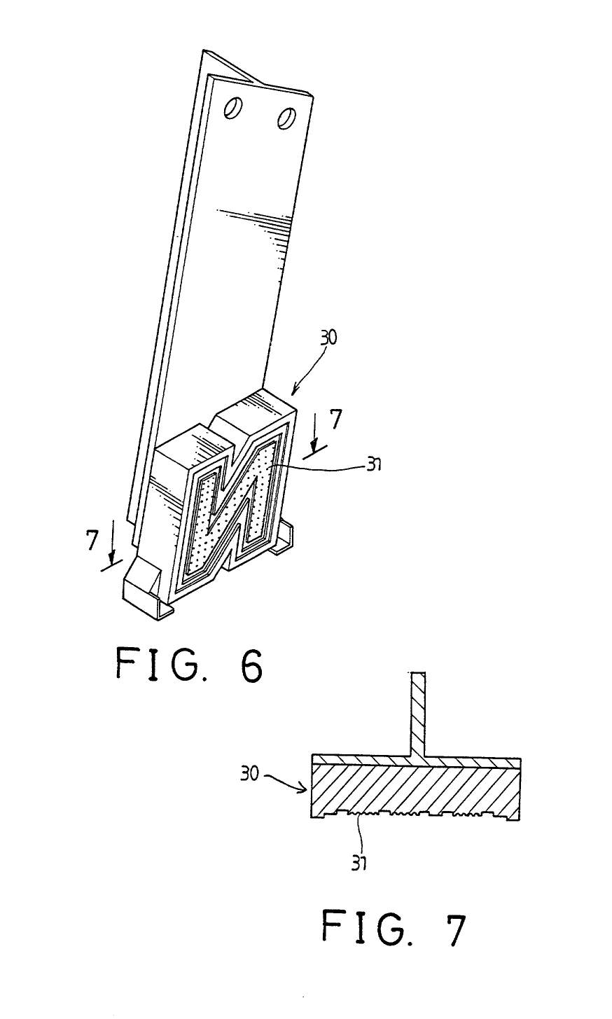

Referring next to FIGS. 6 and 7, illustrated is the mold device 30 for forming or manufacturing the reflective device. The mold device 30 includes one or more of its surfaces having a uneven or rugged or convex and concave surface 31 formed thereon and having a shape corresponding to or serrated or netting surface or the uneven or rugged or convex and concave surface 11 of the cover sheet member 10. The uneven or rugged or convex and concave surface 31 is engaged onto the cover sheet member 10 for forming the corresponding to or serrated or netting surface or the uneven or rugged or convex and concave surface 11 of the cover sheet member 10 with such as the ultrasonic welding processes.

It is to be noted that the transparent or semi-transparent cover sheet member 10 and the base sheet member 20 are inexpensive and may be easily obtained everywhere. The patterns 22, 23 may be easily and directly formed or applied or printed or painted onto the cover sheet member 10, or may be indirectly formed or applied or printed or painted onto the base sheet member 20 and then attached onto the cover sheet member 10. The uneven or rugged or convex and concave surface 11 of the cover sheet member 10 may be easily and quickly formed or manufactured with the mold device 30 by such as the ultrasonic welding processes, without specialized or skillful persons.

In operation, as shown in FIGS. 1 and 2, the sheet members 10, 20 of the reflective device may be attached onto various kinds of objects, such as the shoes, the suitcases, the purses, the clothes, the furniture, the vehicles, or any other objects. The patterns 22, 23 themselves or the patterns 22, 23 of the base sheet member 20 may be seen as a spatial pattern or spatial image via the serrated or netting surface or the uneven or rugged or convex and concave surface 11 of the cover sheet member 10.

Accordingly, the reflective device in accordance with the present invention may be used for reflecting drawing figures into spatial images, and may be manufactured with inexpensive materials, and simple and quick manufacturing processes without specialized or skillful persons.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A reflective device comprising:
a cover sheet member including at least one pattern provided thereon, and
said cover sheet member including a rugged surface formed thereon for reflecting said at least one pattern into a spatial image.

2. The reflective device according to claim 1, wherein said cover sheet member includes a first side and an opposite second side, said at least one pattern is provided on said first side of said cover sheet member, and said rugged surface is formed in said second side of said cover sheet member.

3. The reflective device according to claim 1 further comprising a base sheet member attached onto said cover sheet member, said at least one pattern is applied on said base sheet member.

4. The reflective device according to claim 3, wherein said at least one pattern includes a shape corresponding to that of said base sheet member, and said base sheet member includes an outer peripheral portion and includes a margin formed between said outer peripheral portion of said base sheet member and said at least one pattern.

5. The reflective device according to claim 3, wherein said base sheet member includes a shape corresponding to that of said cover sheet member.
